(19) United States
(12) Patent Application Publication
(10) Pub. No.: US 2024/0424593 A9
(43) Pub. Date: Dec. 26, 2024

(54) ROTATIONAL HANDHELD WELDING GUN AND POWER COUPLING FOR A WELDING GUN

(71) Applicant: NASARC TECHNOLOGIES, INC., Waterloo (CA)

(72) Inventors: Naseem KTEILY, Waterloo (CA); Nauman BASIT, Kitchener (CA)

(21) Appl. No.: 18/561,568

(22) PCT Filed: May 17, 2022
(86) PCT No.: PCT/CA2022/050774

§ 371 Date: Nov. 16, 2023

Related U.S. Application Data
(60) Provisional application No. 63/189,520, filed on May 17, 2021.

(51) Int. Cl. B23K 9/32; H01R 39/64

(52) U.S. Cl. CPC B23K 9/323; H01R 39/64

(57) ABSTRACT

The present disclosure provides a welding gun and a power coupling for a welding gun that permit rotational movement of a handle relative to a cable assembly used by the welding gun. In one aspect, a welding gun comprises; a handle; a supply tube assembly fixedly extending from a front of the handle: a cable assembly configured to supply electrical power; a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly; and an actuator switch assembly electrically coupled to control wires of the cable assembly.

### CROSS-REFERENCE TO RELATED APPLICATIONS

The present application claims priority to U.S. Provisional Patent Application No. 63/189,520 filed May 17, 2021, the entire contents of which is incorporated herein by reference for all purposes.

### TECHNICAL FIELD

The present disclosure relates to welding equipment, and in particular to power coupling for a handheld welding gun.

### BACKGROUND

Handheld welding guns may have a handheld portion and a supply tube assembly portion, and are connected to a cable bundle. The handheld portion is shaped for a user to hold and weld with, and the welding gun is rigidly attached to a cable bundle. Such an attachment does not allow for easy movement of the handheld welding gun.

Instead, to obtain good welding results, the user must hold the welding gun in a stable manner to maintain an accurate position relative to the weld area and a constant speed for consistency. This may result in stress to the wrist and arm of the user. The rigid attachment may also make it more difficult to weld the area. In addition, the heat generated in the welding cable is transferred to the user through the handheld portion, which makes it difficult to weld for longer periods.

Accordingly, an additional, alternative, and/or improved handheld welding gun for welding is desired.

### SUMMARY

In accordance with an aspect of the present disclosure, a welding gun is disclosed, comprising: a handle; a supply tube assembly fixedly extending from a front of the handle; a cable assembly configured to supply electrical power; a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly; and an actuator switch assembly electrically coupled to control wires of the cable assembly.

In some aspects, the rotary power connector is positioned within the handle or at a back of the handle.

In some aspects, the welding gun further comprises a rotatable electrical signal connection electrically coupling the actuator switch assembly to the control wires of the cable assembly.

In some aspects, the rotatable electrical signal connection is rotatable with respect to the cable assembly.

In some aspects, the handle surrounds the rotary power connector and the rotatable electrical signal connection.

In some aspects, the actuator switch assembly is disposed at a side of the handle.

In some aspects, the rotary power connector comprises a housing for connecting to the supply tube assembly and a shaft for connecting to the cable assembly, wherein: the shaft is positioned within the housing, the housing is rotatable with respect to the shaft, and the shaft is configured to transfer electrical power to the housing.

In some aspects, the shaft comprises at least one taper for transferring the electrical power to the housing.

In some aspects, the electrical power is transferred from the shaft to the housing via the at least one taper in contact with a rotor contact.

In some aspects, the welding gun further comprises a heat transfer tube assembly fixed to the cable assembly, the heat transfer tube assembly configured to transfer heat from the cable assembly.

In some aspects, the rotary power connector comprises an opening extending from the front to the back of the rotary power connector.

In some aspects, the cable assembly comprises a hose for shielding gas, and the shielding gas passes through the opening of the rotary power connector to the supply tube assembly.

In some aspects, the cable assembly comprises a conduit for welding wire, and the conduit for welding wire passes through the opening of the rotary power connector to the supply tube assembly.

In some aspects, the cable assembly comprises a hose for working gas, and the working gas passes through the opening of the rotary power connector to the supply tube assembly.

In some aspects, the welding gun is used for gas-metal arc welding with solid wire (GMAW) or metal-cored wires (GMAW-C), gas shielded flux-cored arc welding (FCAW-G), or shielded flux-cored arc welding (FCAW-S).

In some aspects, the welding gun is used for plasma welding or plasma cutting.

In some aspects, the welding gun is a semi-automatic handheld welding gun.

In accordance with another aspect of the present disclosure, a power coupling for a welding gun is disclosed, comprising: a rotary power connector for rotatably coupling between a supply tube assembly and a cable assembly, wherein the rotary power connector permits rotation of the cable assembly with respect to a handle of the welding gun, wherein the cable assembly is configured to supply electrical power and the rotary power connector is configured to transfer electrical power from the cable assembly to the supply tube assembly, and wherein the supply tube assembly fixedly extends from a front of the handle.

In some aspects, the power coupling further comprises a rotatable electrical signal connection for electrically coupling an actuator switch assembly of the welding gun to control wires of the cable assembly.

In some aspects, the rotatable electrical signal connection is rotatable with respect to the cable assembly.

In some aspects, the rotary power connector comprises a housing for connecting to the supply tube assembly and a shaft for connecting to the cable assembly, wherein: the shaft is positioned within the housing, the housing is rotatable with respect to the shaft, and the shaft is configured to transfer electrical power to the housing.

In some aspects, the shaft comprises at least one taper for transferring the electrical power to the housing.

In some aspects, the electrical power is transferred from the shaft to the housing via the at least one taper in contact with a rotor contact.

In some aspects, the rotary power connector comprises an opening extending from the front to the back of the rotary power connector.

In accordance with another aspect of the present disclosure, a welding gun is disclosed, comprising: a handle; a supply tube assembly fixedly extending from a front of the handle; a cable assembly configured to supply electrical power; a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly; an actuator switch assembly disposed at a side of the handle, the actuator switch assembly electrically coupled to control wires of the cable assembly; and a rotatable electrical signal connection that is rotatable with respect to the cable assembly and electrically couples the actuator switch assembly to the control wires of the cable assembly, wherein actuation of the actuator switch assembly sends a signal via the control wires of the cable assembly that controls a welding parameter by the welding gun, and wherein the handle surrounds the rotary power connector and the rotatable electrical signal connection.

### BRIEF DESCRIPTION OF DRAWINGS

Further features and advantages of the present disclosure will become apparent from the following detailed description, taken in combination with the appended drawings, in which:

FIG. 1A depicts a perspective view of an embodiment of a handheld welding gun;

FIG. 1B depicts a front view of the embodiment of the handheld welding gun;

FIG. 1C depicts a side view of the embodiment of a handheld welding gun;

FIG. 2A depicts a cross-sectional view of the handheld welding gun shown in FIG. 1B, taken along the lines A-A;

FIG. 2B depicts an embodiment of a cross-sectional view of the handheld welding gun;

FIG. 3 depicts embodiments of a connection of the supply tube assembly and the RPC;

FIG. 4A depicts an embodiment of a heat transfer tube assembly;

FIG. 4B depicts a cross-sectional view of the heat transfer tube assembly;

FIGS. 4C and 4D depict the heat transfer tube assembly assembled with a rotatable electrical signal connection;

FIGS. 5A and 5B depict embodiments of the rotatable electrical signal connection;

FIG. 6 depicts a rendering of an embodiment of the handheld welding gun;

FIG. 7 depicts an exploded view of an embodiment of the handheld welding gun;

FIG. 8A is an exploded view of an example of a rotary power connector (RPC) suitable for the handheld welding gun;

FIG. 8B is a back view of the RPC;

FIG. 8C is a cross-section view of the RPC;

FIG. 9A depicts a perspective view of another embodiment of a handheld welding gun;

FIG. 9B depicts a front view of the embodiment of the handheld welding gun;

FIG. 9C depicts a side view of the embodiment of a handheld welding gun;

FIG. 10A depicts a cross-sectional view of the handheld welding gun shown in FIGS. 9A-C;

FIG. 10B depicts an embodiment of a cross-sectional view of the handheld welding gun;

FIG. 11 depicts a rendering of an embodiment of the handheld welding gun; and

FIG. 12 depicts an exploded view of an embodiment of the handheld welding gun.

### DETAILED DESCRIPTION

Embodiments of a handheld welding gun and power coupling are disclosed herein. In some aspects, the welding gun comprises a handle; a supply tube assembly fixedly extending from a front of the handle; a cable assembly configured to supply electrical power; a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly; and an actuator switch assembly electrically coupled to control wires of the cable assembly. The welding gun may further comprise a rotatable electrical signal connection electrically coupling the actuator switch assembly to the control wires of the cable assembly, and the rotatable electrical signal connection is rotatable with respect to the cable assembly. Advantageously, the configuration of the welding gun and in particular the rotary power connector and the rotatable electrical signal connection allows the handle and the supply tube assembly to be rotated relative to the cable assembly, thus making it easier for a user who is operating the welding gun to perform welding.

It would be appreciated that a power coupling comprising the rotary power connector and also the rotatable electrical signal connection that allows for rotation relative to an input cable assembly can be used in a range of welding applications, including but not limited to a welding gun used for gas-metal arc welding with solid wire (GMAW) or metal-cored wires (GMAW-C), gas shielded flux-cored arc welding (FCAW-G), or shielded flux-cored arc welding (FCAW-S), or a welding gun used for plasma welding or plasma cutting.

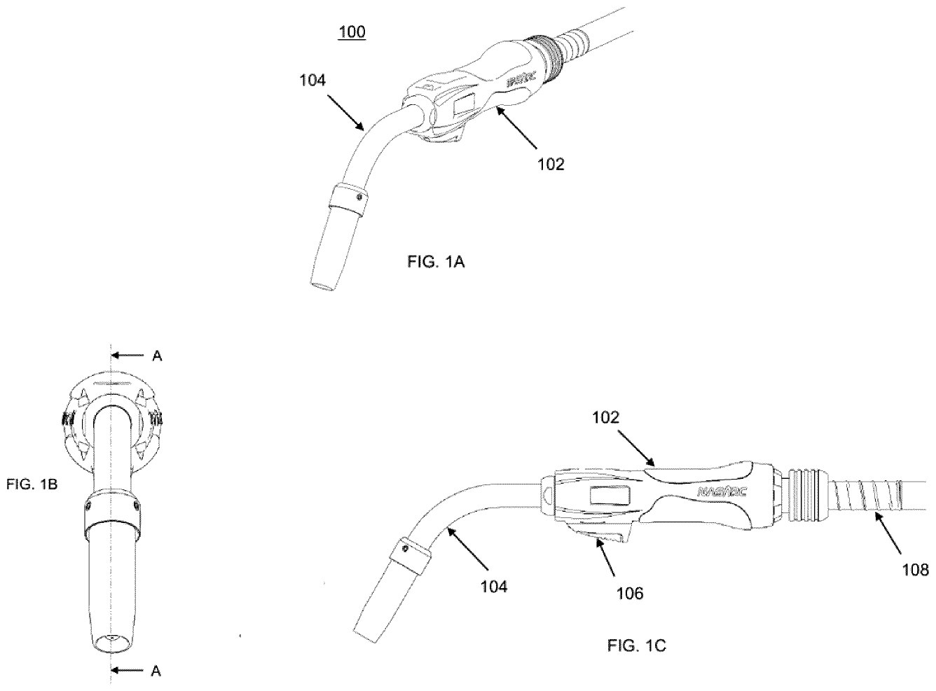

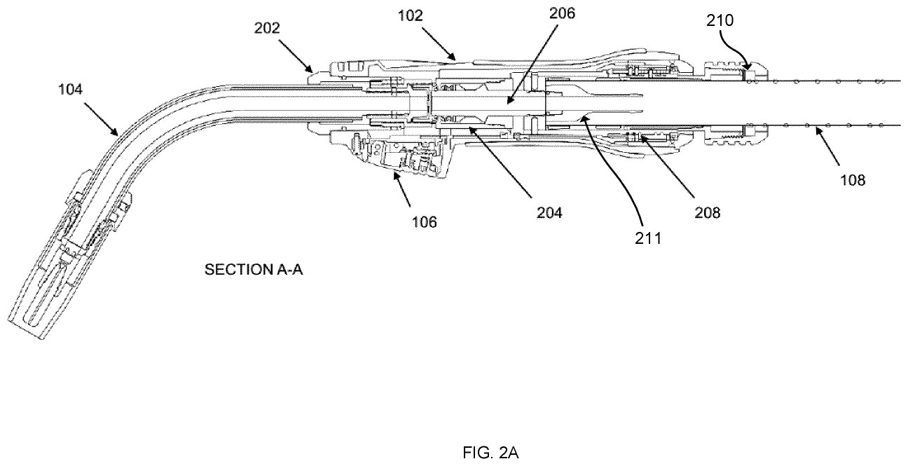

FIGS. 1A-1C depict an embodiment of a handheld welding gun 100 in accordance with the present disclosure. The handheld welding gun 100 comprises a handle 102 and a neck, gooseneck, or supply tube assembly 104 that extends from the handle 102 to the point of welding. The handle 102 is an ergonomic handle shaped for comfort for the hand and wrist of a user. An actuator switch assembly 106 for the handle 102 is used to activate the weld current, wire feed, and shielding gas, and a cable assembly 108 is connected to a back of the handheld welding gun 100. The actuator switch assembly 106 may be a switch disposed on the handle 102 as shown in FIG. 1C. While FIG. 1C depicts the actuator switch assembly 106 as a trigger, it may instead comprise a button or other touch sensor. Further, it would be appreciated that the actuator switch assembly may comprise a separate switching means that is coupled to the handle, such as a foot pedal or a Bluetooth™ switching arrangement. The cable assembly 108 may carry a power cable for conducting electrical current, a hose for shielding gas, conduit for welding wire, and control wires for activating the power supply and wire feeder to the welding gun.

The handle 102 of the handheld welding gun 100 may be straight and have an ergonomic shape, as depicted in FIGS. 1A-1C. However, it will be appreciated that, in some embodiments, the handle 102 may have other shapes/designs and may instead be curved and have an ergonomic shape. The handle 102 may further comprise ridges or surfaces with a different material than other surfaces of the handle 102 to provide better grip for the user. The ergonomic shape of the handle 102 also allows for the user to have a better grip while welding and prevents any discomfort or pain in the hand or wrist while in use.

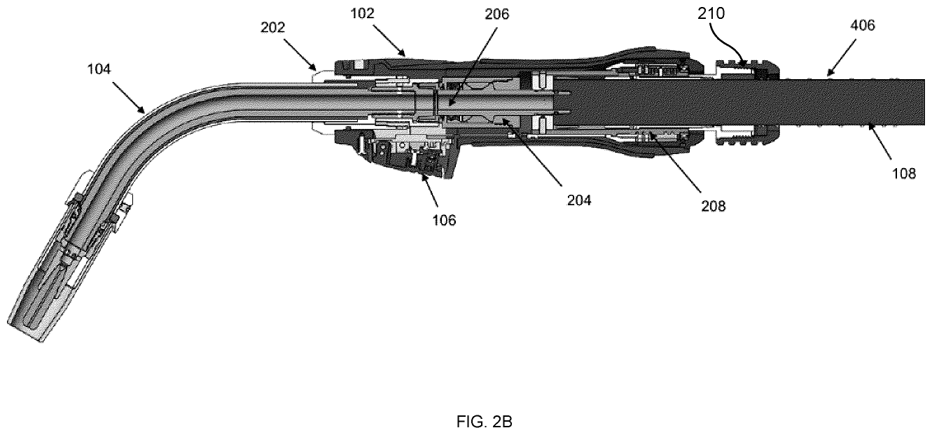

FIGS. 2A and 2B depict cross-sectional views of the handheld welding gun 100. As depicted, the handle 102 may be coupled to supply tube assembly 104 at connection means 202. Connection means 202 may be a removable connection such as a threaded connection. The handheld welding gun 100 further comprises a rotary power connector (RPC) 204 rotatably connected between the cable assembly 108 and the supply tube assembly 104. The RPC 204 is configured to supply power from the cable assembly 108 to the supply tube assembly 104. The RPC 204 may be located within the handle 102, partially within the handle 102, or behind the handle 102. In FIG. 2A, the RPC 204 is located within the handle 102. The cable bundle 108 may be coupled to a back of the RPC 204 via a conductive coupler 211 that allows for connection of the power cable from the cable assembly, and the supply tube assembly 104 may be directly connected to a front of the RPC 204. In particular, the RPC 204 may be coupled to allow for rotation of the cable assembly 108 but may not allow for rotation of the supply tube assembly 104. Thus the supply tube assembly 104 is fixed relative to the handle 102, so that when the handle 102 is rotated the supply tube assembly 104 rotates with the handle 102. It will be appreciated however that the supply tube assembly 104 can be removed from the handle 102, rotated, and then re-installed in a new fixed position. The RPC 204 comprises an opening or through-hole 206 that extends the length of the RPC 204. The opening 206 allows for the shielding gas from the cable assembly 108 to flow from the back to the front of the RPC 204, and allows the conduit for the welding wire to pass through the center of the RPC 204 to the supply tube assembly 104.

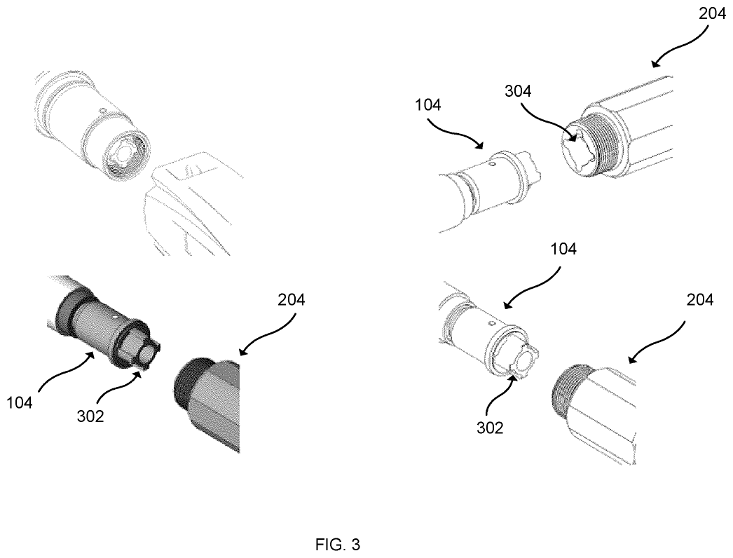

FIG. 3 depicts embodiments of a connection of the supply tube assembly 104 and the RPC 204. The supply tube assembly 104 may be a tapered gooseneck with an indexing feature 302. The indexing feature 302 may be a male connector with a particular shape that fits into a corresponding female connector 304 on the RPC 204. This allows for a secure connection between the RPC 204 and the supply tube assembly 104.

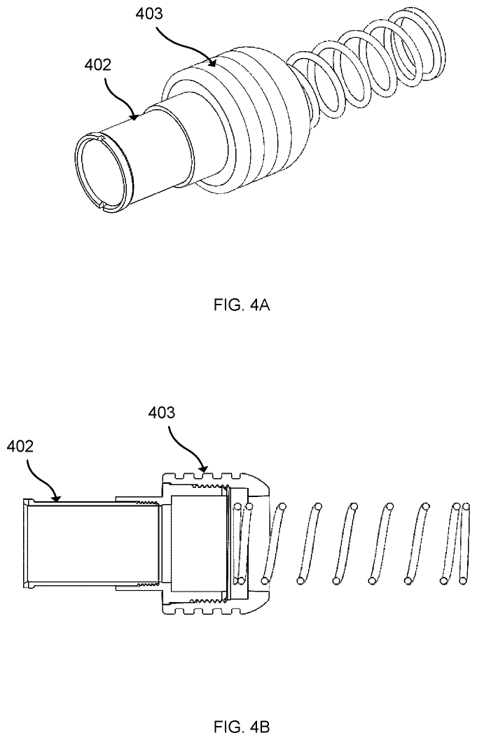

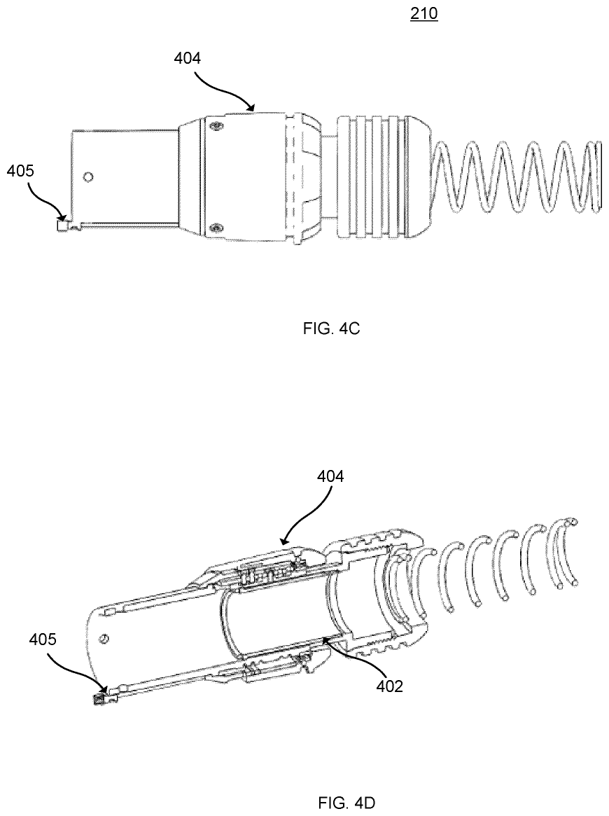

Referring back to FIGS. 2A/2B, the handheld welding gun 100 may further comprise a heat transfer tube assembly 210 fixed to the cable assembly 108 and inserted into a back of the handle 102. FIG. 4A depicts the heat transfer tube assembly 210, FIG. 4B depicts a cross-sectional view of the heat transfer tube assembly 210, and FIGS. 4C and 4D depict the heat transfer tube assembly 210 assembled with a rotatable electrical signal connection 208. As depicted, the heat transfer tube assembly comprises a first portion 402 for directly connecting to the cable assembly 108, and a second portion (rotor 404) which is rotatable with the handle 102 relative to the first portion 402. The heat transfer tube assembly 210 may absorb heat, for example, through conduction and radiation, from the cable assembly 108 and transfer it to the environment, for example, through convection and radiation from fins 403, instead of the heat being transferred to the handle 102 and to a user's hand. This may allow for a user to weld for longer periods of time.

The handheld welding gun 100 may further comprise a rotatable electrical signal connection 208 via, for example, a slip ring assembly. The rotatable electrical signal connection 208 couples the actuator switch assembly 106 to the control wires of the cable assembly 108, and the rotatable electrical signal connection 208 is rotatable with respect to the cable assembly 108 and allows for the supply tube assembly 104 and handle 102 to rotate freely with respect to the cable assembly 108. The rotatable electrical signal connection 208 may be located at various locations of the welding gun 100 to couple the actuator switch assembly 106 to the control wires of the cable assembly 108. As shown in FIG. 2A/2B, the rotatable electrical signal connection 208 is located behind or at a back of the RPC 204. In other embodiments, the rotatable electrical signal connection 208 may be part of the RPC 204.

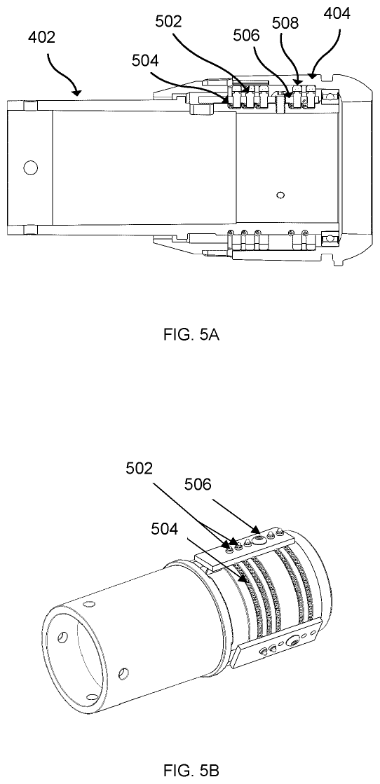

FIGS. 5A and 5B depict embodiments of the rotatable electrical signal connection 208. For each signal transfer circuit, multiple conductive spring-loaded contactors 502 are radially arranged to produce multiple current paths for eliminating noise generated due to vibration and rotation of the handle 102 with respect to the cable 108. These spring-loaded contactors 502 are radially connected to an elastic radial conductor 504, which could be a metallic spring or conductive elastomer. For multiple signals, the spring-loaded contactors 502 are arranged on a PCB 506 in a linear manner. The top part of the spring-loaded contactors 502, which includes a spring-loaded pin portion, protrudes above the PCB 506 and the bottom part extends below the PCB 506. The circular protrusion extending at the bottom tangentially presses against the elastic radial conductor 504. The spring-loaded contactors 502 exert an equal and constant pressure on the conductive rings 508 stacked with insulation layers on the inside of the rotor 404, which is fixed to the handle 102. The spring-loaded contactors 502 on the PCBs 506 are fixed with respect to the cable 108. The signals from the cable 108 are effectively transferred to the handle 102 through this annular compact space. It will be appreciated that, although a slip ring assembly is described and depicted, the rotatable electrical signal connection 208 may comprise another assembly or element that allows for the rotation and electrical connection between the handle 102 and the cable bundle 108.

The ability to rotate the handle 102 with respect to the cable assembly 108 means that the user can move their wrist or hand in order to adapt to any welding position via the handle 102 rotating about the cable assembly 108 with minimal torsional resistance. This allows for reduced stress on the wrist of the user of the welding gun 100, and may relieve the stress in the cable bundle 108, thereby extending the life of the system. The RPC 204 and the rotatable electrical signal connection 208 between the handle 102 and the cable assembly 108 may allow for infinite rotations in both clockwise and counter-clockwise directions. In some embodiments, the RPC 204 and the rotatable electrical signal connection 208 may allow for infinite rotation in either direction, or instead may not allow for full rotations in either direction. It will be appreciated that the RPC 204 and/or the rotatable electrical signal connection 208 may allow for a partial rotation of a degree between 10 degrees and 360 degrees in either direction.

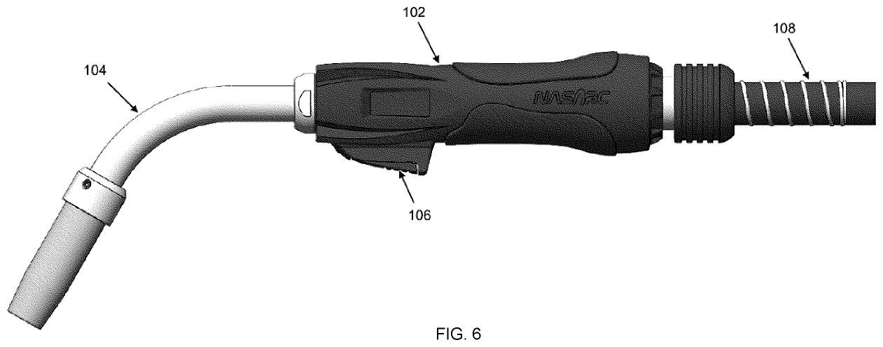

FIG. 6 depicts a rendering of an embodiment of the handheld welding gun, comprising a handle 102, a supply tube assembly 104, an actuator switch assembly 106, and a cable assembly 108.

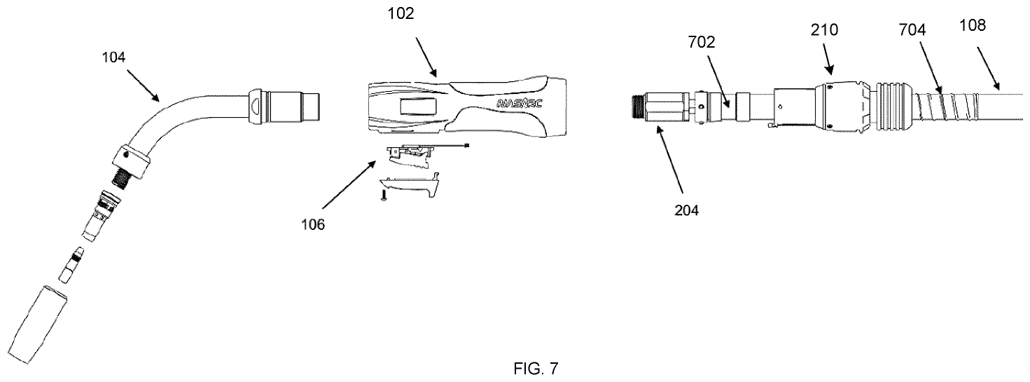

FIG. 7 depicts an exploded view of an embodiment of the handheld welding gun 100. The handle 102 may be formed as one solid piece or may be formed of two or more elements that are connected. The elements may be assembled such that the actuator switch assembly 106 is positioned at a side of the handle 102, the RPC 204 is positioned within the handle 102, and the heat transfer tube assembly 210 is positioned around the cable assembly 108 and coupled to a back of the handle 102. As described above, the cable assembly 108 may comprise the hose for the shielding gas and the conduit for the welding wire 702, and the wire leads which connect to the rotatable electrical signal connection 208. The cable assembly 108 may further comprise a spring 704, or other means for strain relief on the system.

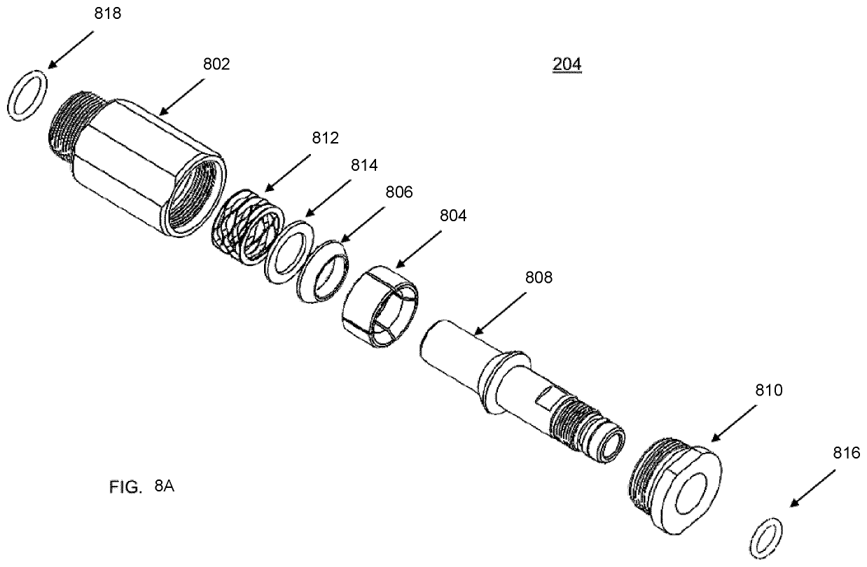

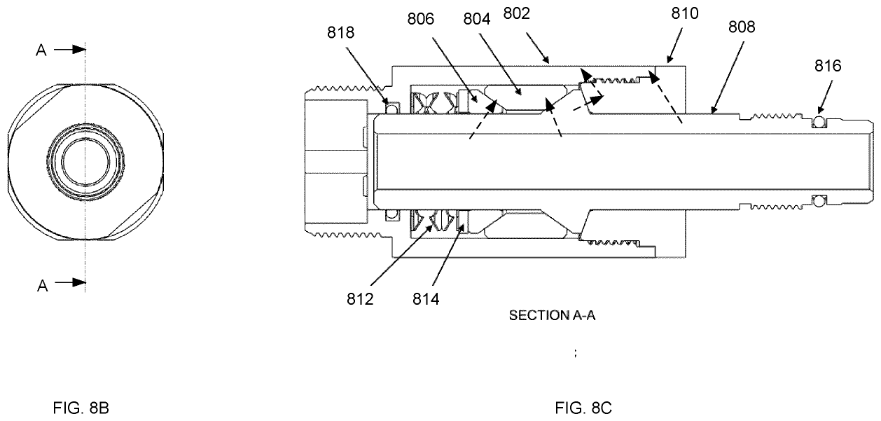

FIG. 8A is an exploded view of an example of the RPC 204 of the handheld welding gun 100. FIG. 8B is a back view of the RPC 204. FIG. 8C is a cross-sectional view of the RPC 204.

The RPC 204 comprises an outer housing 802 that connects to the supply tube assembly 104, rotor contacts 804, a rotor bushing 806, a shaft 808, a bushing nut 810, a spring 812, a pressure plate 814, and O-rings 816, 818. It will be appreciated that, as depicted, the rotor contacts 804 may have four contacts. A power cable (from the cable bundle 108) connects to the shaft 808. As described above, the RPC 204 may have a direct interface with the supply tube assembly 104 and parts of the cable bundle 108. The RPC 204 may be designed so that electrical power is transferred from the shaft 808 to the outer housing 802 through three major current paths (1), (2) and (3) as described below and represented by the dashed arrows in FIG. 8C.

(1) The primary path is from an internal taper of the shaft 808 to the four (4) rotor contacts 804 which connect to the outer housing 802 radially. The rotor contacts 804 are under constant pressure from the spring 812 through the tapered rotor bushing 804. The tapered surfaces of the shaft 808, rotor contacts 804 and rotor bushing 806 ensure a self-centering and concentric rotation of the rotor contacts 804 with respect to the shaft 808 and the outer housing 802.

(2) The secondary current path is from an outside taper of the shaft 808 to the mating internal tapered surface of the outer housing 802. The tapered surface of the shaft 808 also maintains the concentricity of the shaft 808 with respect to the outer housing 802 and ensures even wear of all mating surfaces for extended life of contacts. This tapered interface automatically centers the shaft 808 for smooth rotation. The tapered interface ensures steady pressure on the O-ring 818 which seals the grease and shielding gas and extends its life.

(3) The third current path is from the bushing nut 810 to the outer housing 802. As the power cable which is connected to the shaft 808 is always pushing the shaft 808 away from the rotational axis at some point due to gravitational forces or stress in the power cable, the clearance between the shaft 808 and the bushing 806 is therefore eliminated at that instance and current can directly flow from the shaft 808 to the outer housing 802.

The electrical connection created by multiple paths through contact surfaces under constant pressure can transfer more than 400 amperes of current from the shaft 808 to the outer housing 802 with minimum fluctuation or arcing. The materials may be selected for all the parts to ensure maximum conductivity and ability to withstand heat and friction.

It will be appreciated that the RPC 204 may be designed so that power is transferred from the shaft 808 to the outer housing 802 through three major current paths (1), (2) and (3), as described above, or may be designed to transfer power through one or more of the current paths (1), (2), and (3), or through different current paths in the system.

Referring back to FIGS. 2A and 2B, the actuator switch assembly 106 may be connected to a side of the handle 102 and can electrically connect to the wire leads 405 (shown in FIGS. 4C and 4D) of the cable assembly 108. It will be appreciated that the actuator switch assembly 106 can electrically connect to at least two wire leads of the cable assembly 108 (e.g. on/off signals) to control welding. The actuator switch assembly 106 electrically connects to the wire leads 405 via the rotatable electrical signal connection 208. As described above, the wire leads 405 connect to the rotatable electrical signal connection 208 which electrically connects to the actuator switch assembly 106. This electrical and rotatable connection can allow for infinite rotation between the cable bundle 108 and the actuator switch assembly 106.

The actuator switch assembly 106 may electrically connect the rotatable electrical signal connection 208 via electrical leads. The electrical leads may be long leads which allow for rotation of the actuator switch assembly 106 relative to the cable bundle 108. The electrical leads may allow for full rotation of the actuator switch assembly 106 relative to the cable bundle 108, or may only allow for partial rotation. It will be appreciated that instead of long electrical leads, the actuator switch assembly 106 may comprise a different means or mode for electrically connecting to the rotatable connection 208, for example the electrical connection may be via contact between at least a portion of the actuator switch assembly 106 and the rotatable electrical signal connection 208.

As depicted, the slip ring assembly of the rotatable electrical signal connection 208 may be positioned within the handle such that the cable bundle 108, coupled to the slip ring assembly and the RPC 204, rotates relative to the handle 102 and supply tube assembly 104. It will be appreciated that the slip ring assembly of the rotatable electrical signal connection 208 may be positioned behind the RPC 204 or in another position within the handle 102.

The handheld welding gun 100 may be used as a handheld semi-automatic welding gun as described above. For example, the handheld welding gun 100 can be used for one of many welding processes including but not limited to gas-metal arc welding with solid wire (GMAW) or metal-cored wires (GMAW-C), gas shielded flux-cored arc welding (FCAW-G), or self-shielded flux-cored arc welding (FCAW-S).

In accordance with another embodiment of the present disclosure, a welding gun 1100 is disclosed that may be used for plasma welding or plasma cutting.

Plasma arc welding is an arc welding process where a gas is ionized by passing an electric current through it, creating a plasma arc between an electrode and the workpiece. The plasma is then forced through a nozzle which constricts the arc and the plasma exits the orifice at high velocities and temperatures with shielding gas present around it. Plasma welding guns can be used for welding or cutting. The working gas serves two purposes, generating the plasma and shielding the welding/cutting zone.

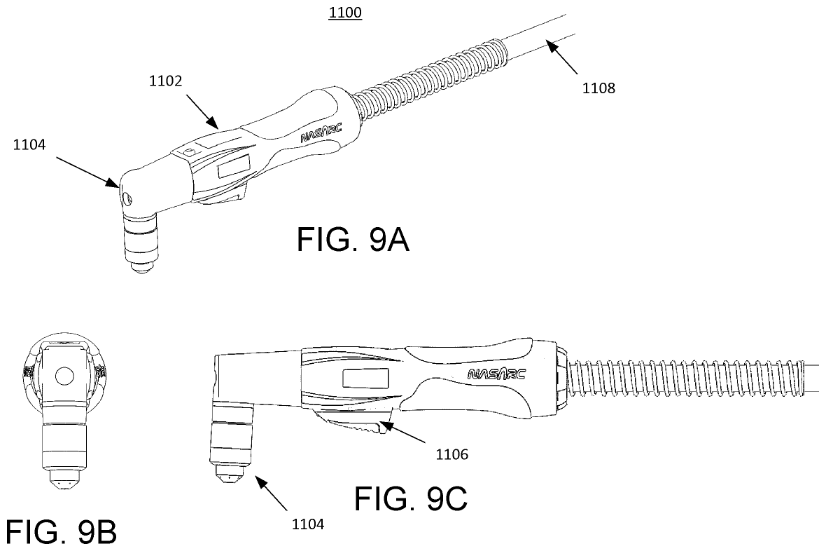

FIG. 9A depicts a perspective view of another embodiment of a handheld welding gun 1100 for plasma welding or cutting. FIG. 9B depicts a front view of the embodiment of the handheld welding gun 1100. FIG. 9C depicts a side view of the embodiment of a handheld welding gun 1100. Similar to the welding gun 100, the welding gun 1100 comprises a handle 1102, a supply tube assembly 1104 extending from a front of the handle 1102, an actuator switch assembly 1106, and a cable assembly 1108 at a back of the handle 1102. In a plasma torch, the cable assembly 1108 supplies electric current and working gas, which are transferred to the working end of the welding gun 1100 at the supply tube assembly 1104.

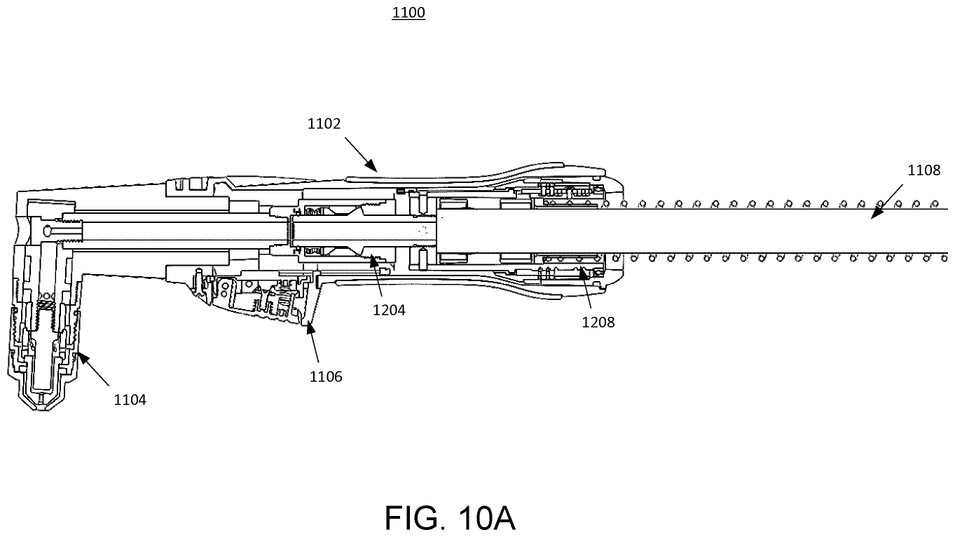

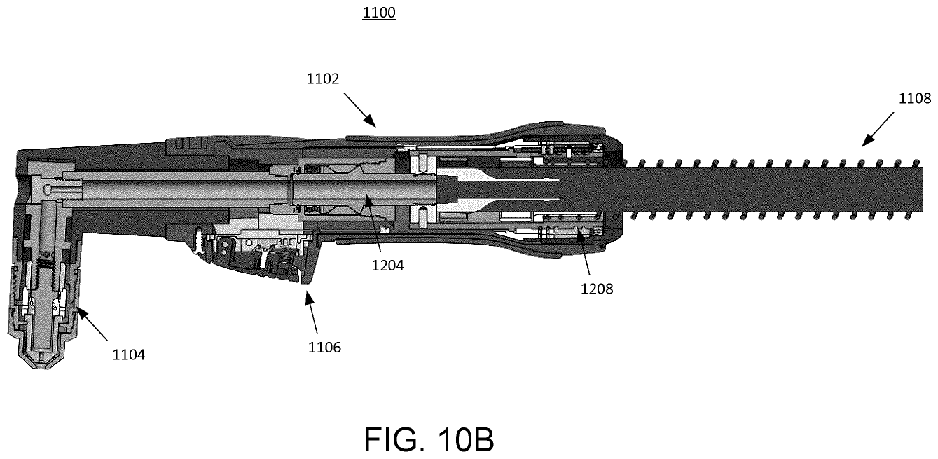

FIG. 10A depicts a cross-sectional view of the handheld welding gun 1100 shown in FIGS. 9A-C. FIG. 10B depicts an embodiment of a cross-sectional view of the handheld welding gun 1100. As seen in FIGS. 10A and 10B, similar to the welding gun 100, the welding gun 1100 further comprises a rotary power connector (RPC) 1204 rotatably connected between the cable assembly 1108 and the supply tube assembly 1104. The welding gun 1100 also comprises a rotatable electrical signal connection 1208 that couples the actuator switch assembly 1106 to the control wires of the cable assembly 1108. The configuration of the RPC 1204 and the rotatable electrical signal connection 1208 is substantially the same as that described with reference to the welding gun 100.

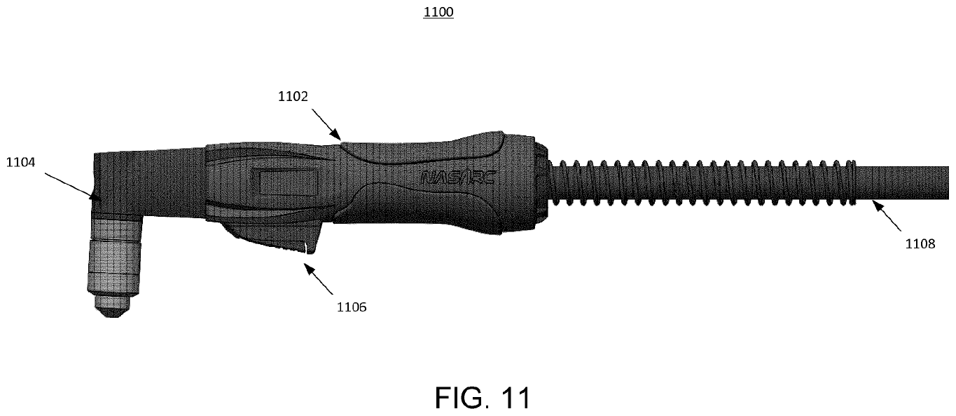

FIG. 11 depicts a rendering of an embodiment of the handheld welding gun 1100, comprising a handle 1102, a supply tube assembly 1104, an actuator switch assembly 1106, and a cable assembly 1108.

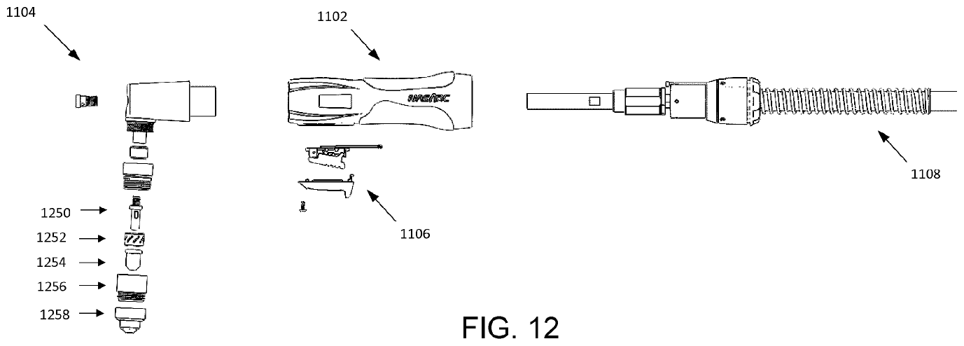

FIG. 12 depicts an exploded view of an embodiment of the handheld welding gun 1100. The cable assembly 1108 supplies the electric current and working gas to the RPC 1204, from where they are transferred to the supply tube assembly 1104. In the supply tube assembly 1104, the working gas is separated into two paths, where a large portion of the gas is shielding gas and the rest of the gas is plasma gas.

The plasma gas enters a central annular region around an electrode 1250 through a swirl ring 1252 where is gains rotational energy through specially designed inlet holes. The plasma gas swirls around the electrode where it is ionized and further transformed into a plasma when an electric current is passed through it. The plasma is then forced through a nozzle 1254 which constricts the arc and the plasma exits the orifice at high velocities (approaching the speed of sound) and a temperature approaching 28,000° C.(50,000° F.) or higher.

The shielding gas bypasses the electrode 1250 and nozzle 1254 from the outside to reach the shielding cap 1258 where it exits through small openings to develop a shield around the welding/cutting zone in use. The shielding cap 1258 is retained by retaining cap 1256, which also holds the nozzle 1254 and swirl ring 1252 in place.

It will be apparent to persons skilled in the art that a number of variations and modifications can be made without departing from the scope of the invention. Although specific embodiments are described herein, it will be appreciated that modifications may be made to the embodiments without departing from the scope of the current teachings. For simplicity and clarity of the illustration, elements in the figures are not necessarily to scale, are only schematic and are non-limiting of the element's structures. It will be apparent to persons skilled in the art that a number of variations and modifications can be made without departing from the scope of the invention as described herein.

1. A welding gun, comprising:
a handle;
a supply tube assembly fixedly extending from a front of the handle;
a cable assembly configured to supply electrical power;
a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly; and
an actuator switch assembly electrically coupled to control wires of the cable assembly.

2. The welding gun of claim 1, wherein the rotary power connector is positioned within the handle or at a back of the handle.

3. The welding gun of claim 1, further comprising a rotatable electrical signal connection electrically coupling the actuator switch assembly to the control wires of the cable assembly.

4. The welding gun of claim 3, wherein the rotatable electrical signal connection is rotatable with respect to the cable assembly.

5. The welding gun of claim 3, wherein the handle surrounds the rotary power connector and the rotatable electrical signal connection.

6. The welding gun of claim 1, wherein the actuator switch assembly is disposed at a side of the handle.

7. The welding gun of claim 1, wherein the rotary power connector comprises a housing for connecting to the supply tube assembly and a shaft for connecting to the cable assembly, wherein:
the shaft is positioned within the housing,
the housing is rotatable with respect to the shaft, and
the shaft is configured to transfer electrical power to the housing.

8. The welding gun of claim 7, wherein the shaft comprises at least one taper for transferring the electrical power to the housing.

9. The welding gun of claim 8, wherein the electrical power is transferred from the shaft to the housing via the at least one taper in contact with a rotor contact.

10. The welding gun of claim 1, further comprising a heat transfer tube assembly fixed to the cable assembly, the heat transfer tube assembly configured to transfer heat from the cable assembly.

11. The welding gun of claim 1, wherein the rotary power connector comprises an opening extending from the a front of the rotary power connector to a back of the rotary power connector.

12. The welding gun of claim 11, wherein the cable assembly comprises a hose for shielding gas, and the shielding gas passes through the opening of the rotary power connector to the supply tube assembly.

13. The welding gun of claim 11, wherein the cable assembly comprises a conduit for welding wire, and the conduit for welding wire passes through the opening of the rotary power connector to the supply tube assembly.

14. The welding gun of claim 11, wherein the cable assembly comprises a hose for working gas, and the working gas passes through the opening of the rotary power connector to the supply tube assembly.

15. The welding gun of claim 1, wherein the welding gun is adapted to be used for gas-metal arc welding with solid wire (GMAW) or metal-cored wires (GMAW-C), gas shielded flux-cored arc welding (FCAW-G), or shielded flux-cored arc welding (FCAW-S).

16. The welding gun of claim 1, wherein the welding gun is adapted to be used for plasma welding or plasma cutting.

17. The welding gun of claim 1, wherein the welding gun is a semi-automatic handheld welding gun.

18. A power coupling for a welding gun, comprising:
a rotary power connector for rotatably coupling between a supply tube assembly and a cable assembly, wherein the rotary power connector permits rotation of the cable assembly with respect to a handle of the welding gun, wherein the cable assembly is configured to supply electrical power and the rotary power connector is configured to transfer electrical power from the cable assembly to the supply tube assembly, and wherein the supply tube assembly fixedly extends from a front of the handle.

19. The power coupling of claim 18, further comprising a rotatable electrical signal connection for electrically coupling an actuator switch assembly of the welding gun to control wires of the cable assembly.

20. The power coupling of claim 19, wherein the rotatable electrical signal connection is rotatable with respect to the cable assembly.

21. The power coupling of claim 18, wherein the rotary power connector comprises a housing for connecting to the supply tube assembly and a shaft for connecting to the cable assembly, wherein:
the shaft is positioned within the housing,
the housing is rotatable with respect to the shaft, and
the shaft is configured to transfer electrical power to the housing.

22. The power coupling of claim 21, wherein the shaft comprises at least one taper for transferring the electrical power to the housing.

23. The power coupling of claim 22, wherein the electrical power is transferred from the shaft to the housing via the at least one taper in contact with a rotor contact.

24. The power coupling of claim 18, wherein the rotary power connector comprises an opening extending from a front of the rotary power connector to a back of the rotary power connector.

25. A welding gun, comprising:
a handle;
a supply tube assembly fixedly extending from a front of the handle;
a cable assembly configured to supply electrical power;
a rotary power connector rotatably coupled between the supply tube assembly and the cable assembly, the cable assembly rotatable with respect to the handle via the rotary power connector, wherein the rotary power connector is configured to transfer electrical power from the cable assembly to the supply tube assembly;
an actuator switch assembly disposed at a side of the handle, the actuator switch assembly electrically coupled to control wires of the cable assembly; and
a rotatable electrical signal connection that is rotatable with respect to the cable assembly and electrically couples the actuator switch assembly to the control wires of the cable assembly,
wherein actuation of the actuator switch assembly sends a signal via the control wires of the cable assembly that controls a welding parameter by the welding gun, and
wherein the handle surrounds the rotary power connector and the rotatable electrical signal connection.
